(19) United States
(12) Patent Application Publication
(10) Pub. No.: US 2024/0069951 A1
(43) Pub. Date: Feb. 29, 2024

(54) EFFICIENTLY AVOIDING PACKET LOOPS WHEN ROUTES ARE AGGREGATED IN A SOFTWARE DEFINED DATA CENTER

(71) Applicant: VMWARE, INC., Palo Alto, CA (US)

(72) Inventors: ANANTHA MOHAN RAJ M.D., Bangalore (IN); DILEEP K. DEVIREDDY, San Jose, CA (US); VIJAI COIMBATORE NATARAJAN, San Jose, CA (US)

(21) Appl. No.: 18/077,248

(22) Filed: Dec. 8, 2022

(30) Foreign Application Priority Data
Aug. 31, 2022 (IN) 202241049720

(51) Int. Cl. G06F 9/455

(52) U.S. Cl. CPC G06F 9/45558; G06F 9/45545; G06F 2009/4557; G06F 2009/45583; G06F 2009/45595

(57) ABSTRACT

The disclosure provides an approach for avoiding packet loops when routes are aggregated in a data center. Embodiments include scanning logical segments associated with a customer gateway to identify network addresses associated with the logical segments. Embodiments include determining one or more recommended supernets based on the network addresses associated with the logical segments. Embodiments include providing output to a user based on the one or more recommended supernets. Embodiments include, based on the output, receiving input from the user configuring an aggregation supernet for the customer gateway. Embodiments include advertising the aggregation supernet to one or more endpoints separate from the customer gateway.

### RELATED APPLICATIONS

Benefit is claimed under 35 U.S.C. 119(a)-(d) to Foreign Application Serial No. 202241049720 filed in India entitled “EFFICIENTLY AVOIDING PACKET LOOPS WHEN ROUTES ARE AGGREGATED IN A SOFTWARE DEFINED DATA CENTER”, on Aug. 31, 2022, by VMware, Inc., which is herein incorporated in its entirety by reference for all purposes.

### BACKGROUND

A software defined datacenter (SDDC) provides a plurality of host computer systems (hosts) in communication over a physical network infrastructure of a datacenter such as an on-premise datacenter or a cloud datacenter. Each host has one or more virtualized endpoints such as virtual machines (VMs), containers, or other virtual computing instances (VCIs). These VCIs may be connected across the multiple hosts in a manner that is decoupled from the underlying physical network, which may be referred to as an underlay network. The VCIs may be connected to one or more logical overlay networks which may be referred to as software-defined networks (SDNs) and which may each span multiple hosts. The underlying physical network and the one or more logical overlay networks may use different addressing. Though certain aspects herein may be described with respect to VMs, it should be noted that the techniques herein may similarly apply to other types of VCIs.

Any arbitrary set of VCIs in a datacenter may be placed in communication across a logical Layer 2 network by connecting them to a logical switch. A logical switch is collectively implemented by at least one virtual switch on each host that has a VCI connected to the logical switch. Virtual switches provide packet forwarding and networking capabilities to VCIs running on the host. The virtual switch on each host operates as a managed edge switch implemented in software by the hypervisor on each host. As referred to herein, the terms “Layer 2,” “Layer 3,” etc. refer generally to network abstraction layers as defined in the OSI model. However, these terms should not be construed as limiting to the OSI model. Instead, each layer should be understood to perform a particular function which may be similarly performed by protocols outside the standard OSI model. As such, methods described herein are applicable to alternative networking suites.

A logical Layer 2 network infrastructure of a datacenter may be segmented into a number of Layer 2 (L2) segments, each L2 segment corresponding to a logical switch and the VCIs coupled to that logical switch. In some cases, one or more L2 segments may be organized behind a customer gateway (e.g., a Tier-1 service router) that is internal to the datacenter and connects endpoints in the one or more L2 segments to other endpoints within the data center, including an edge gateway (e.g., a Tier-0 service router) that provides connectivity between endpoints inside the data center and endpoints external to the data center. A cloud connection service may further enable connectivity between endpoints behind the customer gateway and external cloud endpoints, such as web services. For example, the cloud connection service may utilize a distributed router (e.g., a virtual distributed router or VDR) that provides mappings between endpoints behind the customer gateway and an elastic network interface (ENI) or other comparable network interface associated with the external cloud endpoints. A VDR is an implementation of a logical router that operates in a distributed manner across different host machines, with a corresponding VDR being located on each host machine that implements the logical router. An uplink of the VDR may be connected to the ENI and a downlink of the VDR may be connected to the edge gateway, which is in turn connected to one or more customer gateways, behind which are VCIs.

Certain cloud providers may have a limit on a number of routes that can be programmed into a routing table. In some cases a number of logical segments and/or VCIs behind one or more customer gateways may exceed the limit of routes allowed by a cloud provider associated with an ENI. As such, route aggregation may be used. Route aggregation involves summarizing a plurality of routes into a “supernet” that encompasses the plurality of routes and advertising the supernet rather than separately advertising each of the plurality of routes. For example, network addresses behind a customer gateway may be summarized by a supernet that is configured by an administrator via the cloud connection service, and the cloud connection service may program the supernet into the VDR connected to the ENI so that the supernet, instead of the individual routes that are summarized by the supernet, is advertised to the ENI.

However, a configured aggregation supernet for a customer gateway may include network address that are not actually included in any L2 segments behind the customer gateway, as the supernet may cover an overly broad range of network addresses. Thus, it is possible that a packet addressed to a network address included in the supernet, but not actually included in any of the L2 segments behind the customer gateway, could be received by the edge gateway. When such a packet is received at the edge gateway, it may be routed to the VDR (e.g., for transmission over an intranet route), as the edge gateway may determine that it does not correspond to an L2 segment behind a customer gateway. However, when the packet is received at the VDR, the VDR may route the packet back to the edge gateway, as the VDR is configured with the aggregation supernet that includes the network address to which the packet is addressed, and will route all packets within the supernet towards the edge gateway (believing they correspond to the customer gateway). This may cause a packet loop between the edge gateway and the VDR, thereby interfering with performance of both components. Performance loss at the edge gateway in particular due to such a packet loop could cause significant performance and connectivity issues for the data center.

As such, there is a need in the art for techniques of avoiding packet loops when routes are aggregated in a data center.

### BRIEF DESCRIPTION OF THE DRAWINGS

FIG. 1 is an illustration of example physical and virtual network components with which embodiments of the present disclosure may be implemented.

FIG. 2 is an illustration of an example arrangement of computing components related to route aggregation in a data center.

FIG. 3 is an illustration of an example related to route aggregation in a data center.

FIG. 4 is an illustration of an example related to recommending supernets for avoiding packet loops when routes are aggregated in a data center.

FIG. 5 is an illustration of example techniques for avoiding packet loops when routes are aggregated in a data center.

FIG. 6 is a flow chart related to avoiding packet loops when routes are aggregated in a data center.

FIG. 7 depicts example operations related to avoiding packet loops when routes are aggregated in a data center.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for avoiding packet loops when routes are aggregated in a data center. According to certain embodiments, logical segments behind customer gateways in a data center are scanned to determine optimal supernets to be used for route aggregation (e.g., supernets that do not include network addresses outside of the logical segments). These computed optimal supernets may be recommended to the administrator for use in configuring aggregation supernets and/or may be used to verify whether aggregation supernets configured by the administrator are substantively coextensive with the logical segments that they are intended to summarize.

Furthermore, once an aggregation supernet is configured, certain embodiments involve programming “black hole” or null routes at an edge gateway based on the configured aggregation supernet. For example, one or more entries may be programmed into a routing table associated with the edge gateway indicating a blank or null next hop for packets directed to addresses in the configured aggregation supernet that are not actually included in the logical segments summarized by the configured aggregation supernet. A black hole route may cause packets addressed to such a network address to be dropped by the edge gateway and, in some embodiments, a notification may be generated in order to alert a system administrator that the packet was addressed to a network address not included in the applicable logical segments and was dropped accordingly.

Thus, by proactively recommending optimal aggregation supernets and also by utilizing black hole routes, techniques described herein both prevent misconfiguration of aggregation supernets and remediate cases where a packet loop may otherwise occur.

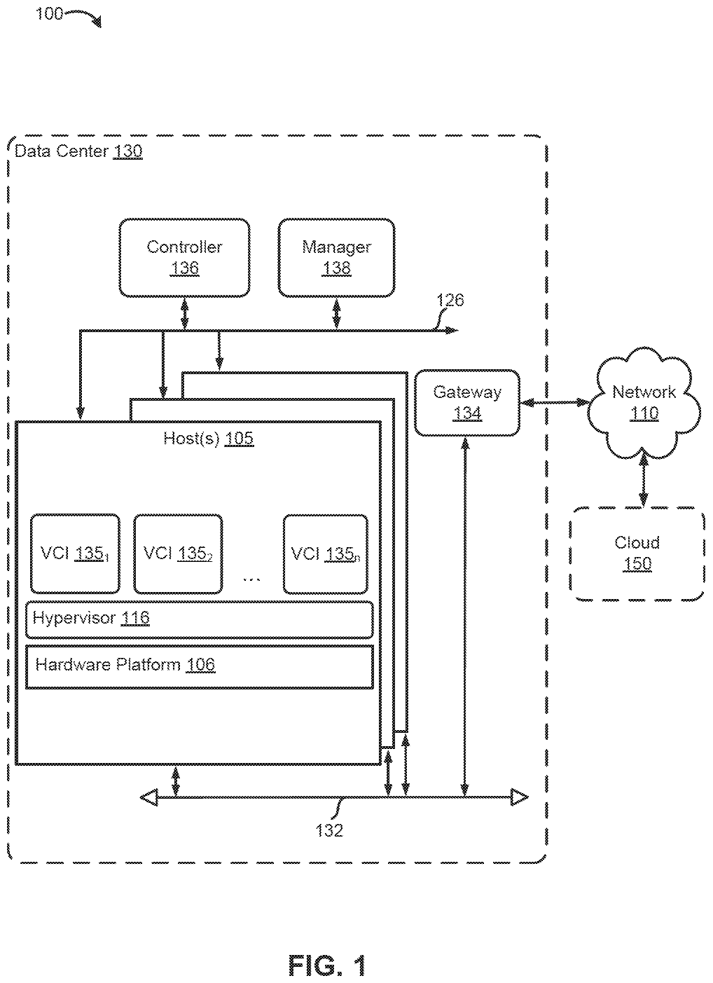

FIG. 1 is an illustration of example physical and virtual network components with which embodiments of the present disclosure may be implemented.

Networking environment 100 includes data center 130 connected to network 110. Network 110 is generally representative of a network of machines such as a local area network (“LAN”) or a wide area network (“WAN”), a network of networks, such as the Internet, or any connection over which data may be transmitted.

Data center 130 generally represents a set of networked machines and may comprise a logical overlay network. Data center 130 includes host(s) 105, a gateway 134, a data network 132, which may be a Layer 3 network, and a management network 126. Host(s) 105 may be an example of machines. Data network 132 and management network 126 may be separate physical networks or different virtual local area networks (VLANs) on the same physical network.

While not shown, one or more additional data centers may be connected to data center 130 via network 110, and may include components similar to those shown and described with respect to data center 130. Communication between the different data centers may be performed via gateways associated with the different data centers. A cloud 150 is also connected to data center via network 110. Cloud 150 may, for example, be a cloud computing environment that includes one or more cloud services such as web services.

Each of hosts 105 may include a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 for multiple virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like. VCIs 135 may be an example of machines.

In certain aspects, hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

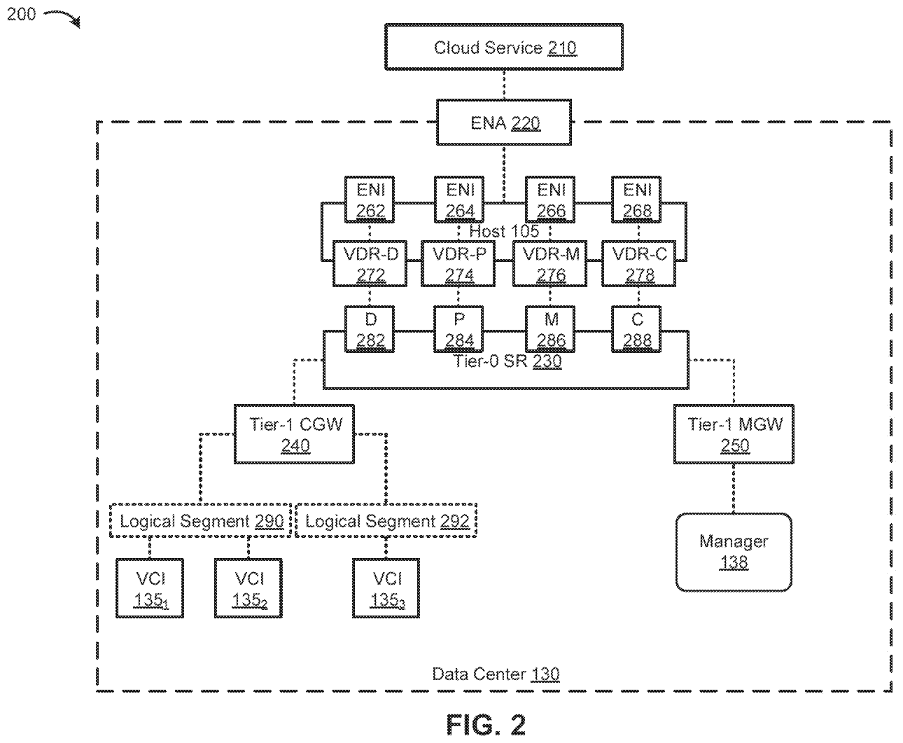

Gateway 134 is an edge gateway that provides VCIs 135 and other components in data center 130 with connectivity to network 110, and is used to communicate with destinations external to data center 130 (not shown). As described in more detail below with respect to FIG. 2, gateway 134 may comprise a Tier-0 service router (SR), and may further communicate with one or more customer gateways comprising Tier-1 SRs that are internal to data center 130. Gateway 134 may be implemented as one or more VCIs, physical devices, and/or software modules running within one or more hosts 105. In one example, gateway 134 is implemented as a VCI that executes edge services gateway (ESG) software. The ESG software may provide a number of network services for connected software-defined networks such as firewall, load balancing, intrusion detection, domain name, DHCP, and VPN services. It is also possible to implement gateway 134 directly on dedicated physical computer hardware (i.e., without a hypervisor layer).

Gateway 134 may be connected to one or more corresponding gateways in other data centers (not shown). Gateway 134 may further communicate with a VDR implemented on one or more hosts 105, such as to communicate with an elastic network interface (ENI) or similar network interface associated with one or more cloud services (e.g., running in cloud 150), as described in more detail below with respect to FIG. 2. For instance, the VDR may be associated with a cloud connection service that facilitates connectivity between data center 130 and cloud 150. The ENI may provide connectivity between the VDR and an elastic network adapter (ENA) or similar network adapter of the one or more cloud services that enables the one or more cloud services to communicate with outside endpoints (e.g., in data center 130).

Controller 136 generally represents a control plane that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, manager 138 is a computer program that executes in a central server in networking environment 100, or alternatively, manager 138 may run in a VM, e.g. in one of hosts 105. Manager 138 is configured to receive inputs from an administrator or other entity, e.g., via a web interface or API, and carry out administrative tasks for data center 130, including centralized network management and providing an aggregated system view for a user.

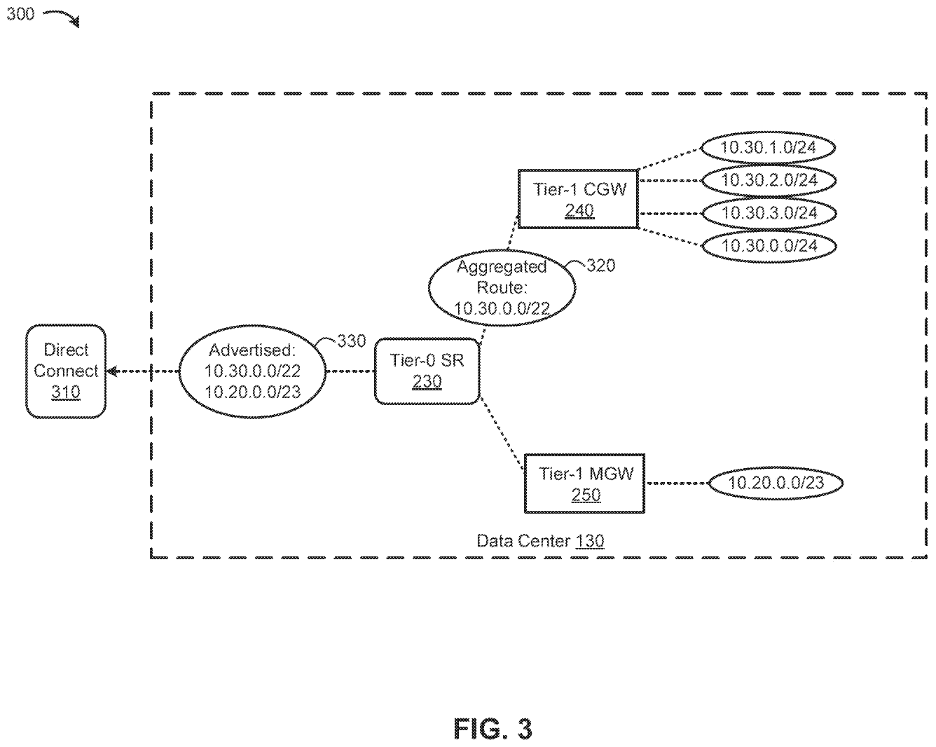

As described in more detail below with respect to FIG. 2, one or more VCIs 135 may be organized into one or more logical segments behind one or more customer gateways. For example, each VCI 135 may be assigned a network address from a range of network addresses that is associated with a corresponding logical segment. Furthermore, as described in more detail below with respect to FIG. 3, route aggregation may be used to summarize routes associated with a customer gateway so that a single supernet is advertised for the customer gateway to other endpoints such as the cloud connection service and, consequently, the VDR, the ENI, and/or the ENA.

FIG. 2 is an illustration of an example arrangement 200 of computing components related to route aggregation in a data center. Arrangement 200 includes data center 130, VCIs 135, and host 105, all previously described with reference to FIG. 1.

VCIs 135₁ and 135₂ are included in logical segment 290 and VCI 135₃ is included in logical segment 292. Logical segments 290 and 292 may be L2 segments, and each may be associated with a range of network addresses, such as internet protocol (IP) addresses, in a subnet. For example, a logical segment may be associated with the subnet 10.30.1.0/24, which is specified in Classless Inter-Domain Routing (CIDR) notation, having a subnet prefix length of /16 (included as an example). A subnet prefix length generally indicates a number of bits that are included in a subnet mask. The prefix (or network portion) of an IP address can be identified by a dotted-decimal netmask, commonly referred to as a subnet mask. For example, 255.255.255.0 indicates that the network portion (or prefix length) of the IP address is the leftmost 24 bits. The 255.255.255.0 subnet mask can also be written in CIDR notation as /24, indicating that there are 24 bits in the prefix. A subnet with a CIDR prefix length of /24 (e.g., with a subnet mask of 255.255.255.0) includes a total of 255 possible addresses that could potentially be assigned to endpoints in the subnet (although there may be addresses reserved for certain purposes, such as a broadcast address). While examples described herein correspond to IPv4 addressing, the same approach can be applied to IPv6 addresses and other addressing schemes where a prefix or subset of address bits correspond to a subnet. In some cases the term “CIDR” may be used to refer to a subnet that is denoted in CIDR notation.

VCIs within a logical segment are assigned network addresses from the subnet corresponding to the logical segment. For example, if logical segment 290 corresponds to the subnet 10.30.1.0/24, VCI 135₁ may be assigned the IP address 10.30.1.1, and VCI 135₂ may be assigned the IP address 10.30.1.2.

Logical segments 290 and 292 are located behind a Tier-1 customer gateway (CGW) 240. Tier-1 CGW 240 is a gateway that is internal to data center 130 and facilitates segmentation of endpoints in the data center 130 (e.g., by tenant, project, and/or other units of administration). For example, Tier-1 CGW 240 may be configured by a network administrator in order to dedicate workload network capacity to a specific project, tenant, or other unit of administration. While a single Tier-1 CGW 240 is shown, there may be multiple CGWs in data center 130. A tier-1 management gateway (MGW) 250 provides dedicated workload network capacity to components of data center 130 related to management, such as manager 138, and may also provide a higher level of security for such components (e.g., preventing unauthorized access).

Tier-0 SR 230 may be representative of an edge gateway, such as gateway 134 of FIG. 1. Tier-0 SR 230 provides connectivity between Tier-1 CGW 240 and Tier-1 MGW 150 and external endpoints, including via one or more VDRs implemented on host 105. Tier-0 SR 230 comprises a direct connect (D) interface 282, a public (P) interface 284, a management (M) interface 286, and a cross virtual private cloud (VPC) (C) interface 288, each of which corresponds to an equivalent VDR implemented on host 105 (e.g., VDR-D 272, VDR-P 274, VDR-M 286, and VDR-C 278). VDR-D 272, VDR-P 274, VDR-M 286, and VDR-C 278 connect to, respectively, ENIs 262, 264, 266, and 268 which enable connectivity to cloud service 210 via ENA 220. Direct connect, public, management, and cross-VPC traffic may be handled by corresponding interfaces and VDRs. For example, the direct connect interface 282 and corresponding VDR-D 272 facilitate direct traffic between CGW 240 and cloud service 210. For example, a packet sent by cloud service 210 and directed to a network address of VCI 135₁ may be transmitted via ENA 220 and ENI 262 to VDR-D 272 and then to Tier-0 SR 230 via the D interface 282. Tier-0 SR 230 may determine that the packet is directed to a network address within logical segment 290, and may route the packet to Tier-1 CGW 240 accordingly. Tier-1 CGW 140 may then route the packet to VCI 135₁. The reverse of this process may be used to route traffic from a VCI 135 to cloud service 210.

Cloud service 210 may be a web service located in cloud 150 of FIG. 1. In some embodiments, a provider of cloud service 210 places a limit on a number of routes that can be programmed into a corresponding routing table. As such, it may be advantageous to utilize route aggregation to summarize routes within logical segments behind Tier-1 CGW 240 into a supernet, so that the supernet can be advertised rather than the subnets of each logical segment. Thus, a single routing table entry can be programmed for cloud service 210 for the supernet rather than separate entries for a plurality of routes summarized by the supernet. Route aggregation is described in more detail below with respect to FIG. 3.

FIG. 3 is an illustration 300 of an example related to recommending supernets for avoiding packet loops when routes are aggregated in a data center. FIG. 3 data center 130, Tier 1 CGW 240, Tier-1 MGW 250, and Tier-0 SR 230 of FIG. 2.

Behind Tier-1 CGW 240 are logical segments having the subnets 10.30.1.0/24, 10.30.2.0/24, 10.30.3.0/24, and 10.30.0.0/24. For example, these subnets may correspond to logical segments 290 and 292 of FIG. 2 and two additional logical segments not shown in FIG. 2. Tier-1 MGW 250 corresponds to the subnet 10.20.0.0/23.

An aggregated route 320 is configured for Tier-1 CGW 240. For example, an administrator may configure aggregated route 320 via a cloud connection service. Aggregated route 320 summarizes the routes included in the logical segments behind Tier-1 CGW 240 into the supernet 10.30.0.0/22 (which encompasses subnets 10.30.1.0/24, 10.30.2.0/24, 10.30.3.0/24, and 10.30.0.0/24).

Advertised routes 330 by Tier-0 SR 230 include 10.30.0.0/22 (which is the aggregated route 320 for Tier-1 CGW 240) and 10.20.0.0/23 (which is the only subnet corresponding to Tier-1 MGW 250). For example, Tier-0 SR 230 advertises these routes to direct connect 310, which may correspond to direct connect interface 282 and VDR-D 272 of FIG. 2. Thus, advertised routes 230 are used to program routes into a routing table associated with cloud service 210 of FIG. 2.

As described above, a packet loop may occur in a case where a packet directed to a network address included in aggregated route 10.30.0.0/22 but not included in any of subnets 10.30.1.0/24, 10.30.2.0/24, 10.30.3.0/24, and 10.30.0.0/24 is received by Tier-0 SR 230. An example of such an IP address could be 10.30.30.1. Tier-0 SR 230 may determine that 10.30.30.1 is not included in a logical segment within data center 130, and so may route the packet to a default route (e.g., for intranet routes) pointing to VDR-D 272 via the direct connect interface 282. VDR-D 272 may determine that 10.30.30.1 falls within aggregated route 320 (supernet 10.30.0.0/22), and so may route the packet back to Tier-0 SR 230, resulting in a packet loop.

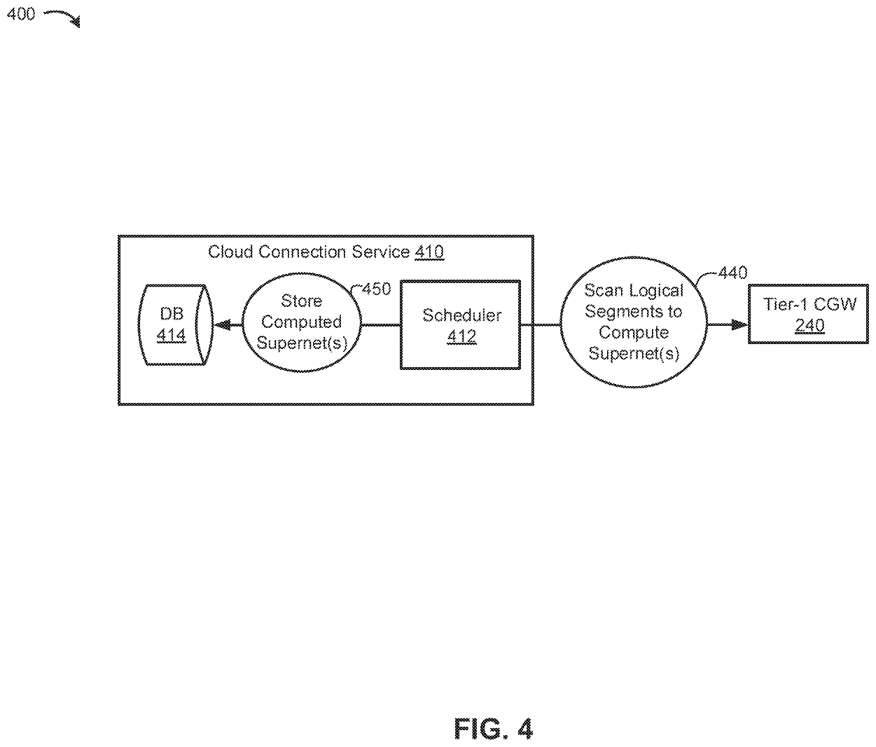

Such packet loops may be prevented via a configurable unicast reverse path forwarding (URPF) “strict” mode, although strict mode is often disabled by administrators for various purposes. In strict mode, packets are dropped by the edge gateway unless they meet both of the following conditions: the source IP address of the packet received is present in the routing table; and the source IP address of the packet received is reachable via the interface on which the packet has been received. In some cases (e.g., asymmetrical routing), strict mode might discard valid packets, and so strict mode may be disabled. Accordingly, as described in more detail below with respect to FIGS. 4-7, embodiments of the present disclosure involve preventing misconfiguration of aggregation supernets and remediating cases where packet loops may otherwise occur when URPF strict mode is disabled.

FIG. 4 is an illustration 400 of an example related to recommending supernets for avoiding packet loops when routes are aggregated in a data center. FIG. 4 includes Tier-1 CGW 240 of FIGS. 2 and 3.

A cloud connection service 410 facilitates communication between endpoints in data center 130 and cloud services, such as cloud service 210. For example, cloud connection service 410 may utilize VDRs that map to interfaces associated with an ENA of a cloud service to enable such communication, as described above.

Cloud connection service comprises a scheduler 412, which performs certain operations related to avoiding packet loops. In alternative embodiments, scheduler 412 is separate from cloud connection service 410.

Scheduler 412, at step 440, scans logical segments behind Tier-1 CGW 240 in order to compute one or more supernets that may be used to summarize the logical segments for the purposes of route aggregation. In some embodiments, the scheduler runs at regular time intervals (e.g., every five minutes), and scans all logical segments behind all CGWs (e.g., Tier-1 CGW 240) in the datacenter. Scheduler 240 may group the logical segments based on a comparison of octets in the logical segments.

In an example, scheduler 412 identifies the following CIDRs behind a CGW: 192.168.98.0/24; 192.168.99.0/24; 192.168.100.0/24; 192.168.101.0/24; 192.168.102.0/24; and 192.168.105.0/24. Scheduler 412 converts these CIDRs into binary form as follows:
192.168.98.0/24 is converted to 11000000.10101000.01100010.00000000;
192.168.99.0/24 is converted to 11000000.10101000.01100011.00000000;
192.168.100.0/24 is converted to 11000000.10101000.01100100.00000000;
192.168.101.0/24 is converted to 11000000.10101000.01100101.00000000;
192.168.102.0/24 is converted to 11000000.10101000.01100110.00000000; and
192.168.105.0/24 is converted to 11000000.10101000.01101001.00000000.

Next, scheduler 412 locates the bits at which the common pattern of digits ends. In the above example, the first and second octets of each of the CIDRs have common bits, and the first four bits of the third octet are shared in common as well. The number of common bits is counted, in this case the number being 20. The aggregation supernet is then determined by setting the remaining bits to zero (e.g., 11000000.10101000.01100000.00000000) and using the number of common bits as the prefix length (e.g., /16). Thus, an aggregation supernet of 192.168.96.0/20 is determined.

If no common pattern of bits is identified in the first two octets of the identified CIDRs, the CIDRs may be considered non-matching, and no aggregation may be applied and/or a recommendation of no aggregation may be provided to the administrator. If a subset of the CIDRs share a common bit pattern with one another but not with other CIDRs outside of the subset, then an aggregation supernet may be determined for the subset (e.g., multiple aggregation supernets may be determined for subsets of CIDRs within a single CGW).

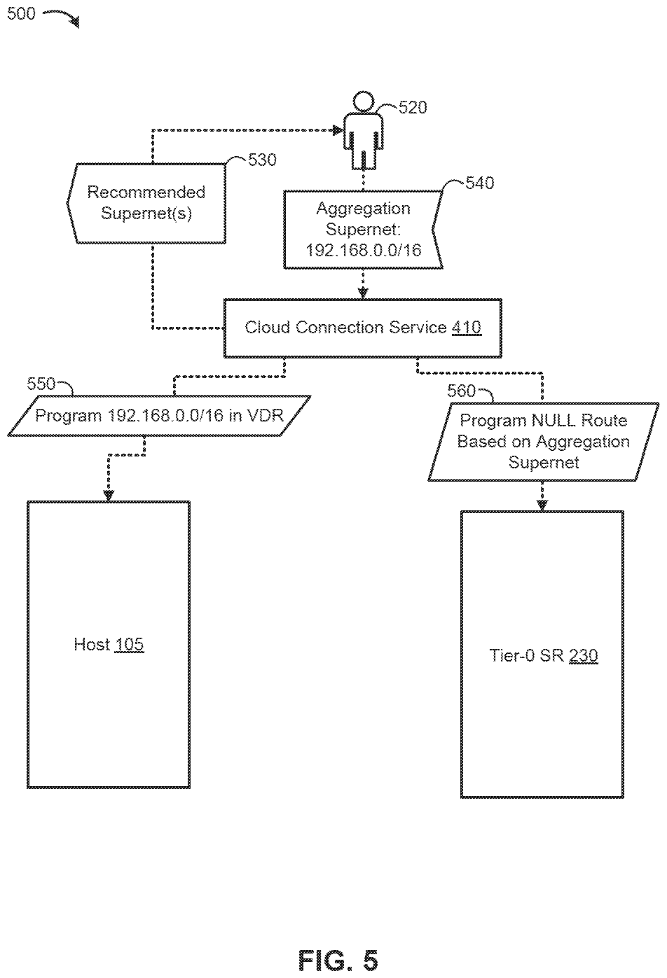

Scheduler 412, at step 450, may store the computed supernet or supernets (if multiple CGWs are scanned and/or if logical segments behind a single CGW are broken up into multiple supernets) in a database (DB) 414. DB 414 may alternatively be separate from cloud connection service 410. DB 414 generally refers to a data storage entity that stores data related to aggregation supernets for use in recommending supernets to an administrator and/or verifying aggregation supernets configured by an administrator. Recommending and/or verifying aggregation supernets is described in more detail below with respect to FIG. 5.

Scheduler 412 may additionally identify network addresses that are assigned to endpoints (e.g., VCIs) within the logical segments behind a CGW, and may also store the identified network addresses in DB 414. For example, storing the network addresses that are actually assigned to endpoints may provide insight into which network addresses are still available within a given aggregation supernet and which are used. This may assist with programming black hole routes, as described in more detail below with respect to FIG. 5.

FIG. 5 is an illustration 500 of example techniques for avoiding packet loops when routes are aggregated in a data center. FIG. 5 includes host 105 and Tier-0 SR 230 of FIG. 2 and cloud connection service 410 of FIG. 4.

A user 520, such as an administrator, interacts with cloud connection service 410 in order to configure route aggregation for one or more CGWs within the datacenter.

Cloud connection service 410 provides one or more recommended supernets 530 to user 520. For example, recommended supernets 530 may include one or more supernets computed as described above with respect to FIG. 4 and stored in DB 414. User 520 inputs an aggregation supernet 540 of 192.168.0.0/16. In some embodiments, aggregation supernet 540 is verified by comparing it to computed aggregation supernets (e.g., stored in DB 414). For example, if aggregation supernet 540 does not match a computed aggregation supernet, then cloud connection service 410 may provide output to user 520 indicating that the aggregation supernet is not recommended (e.g., with an explanation that it includes network addresses that are not included in the logical segments it is intended to summarize) and, in some embodiments, recommending a computed aggregation supernet. Thus, cloud connection service 410 may prevent or reduce opportunities for misconfiguration of aggregation supernets by user 520, thereby reducing the likelihood of packet loops.

Once user 520 has configured aggregation supernet 540, cloud connection service 410 programs the configured aggregation supernet into routing tables associated with one or more VDRs on host 105 at step 550. For example, one or more routing table entries may be created for VDR-D 272 corresponding to the supernet 192.168.0.0/16 (e.g., routing packets that are addressed to this supernet to Tier-0 SR 230).

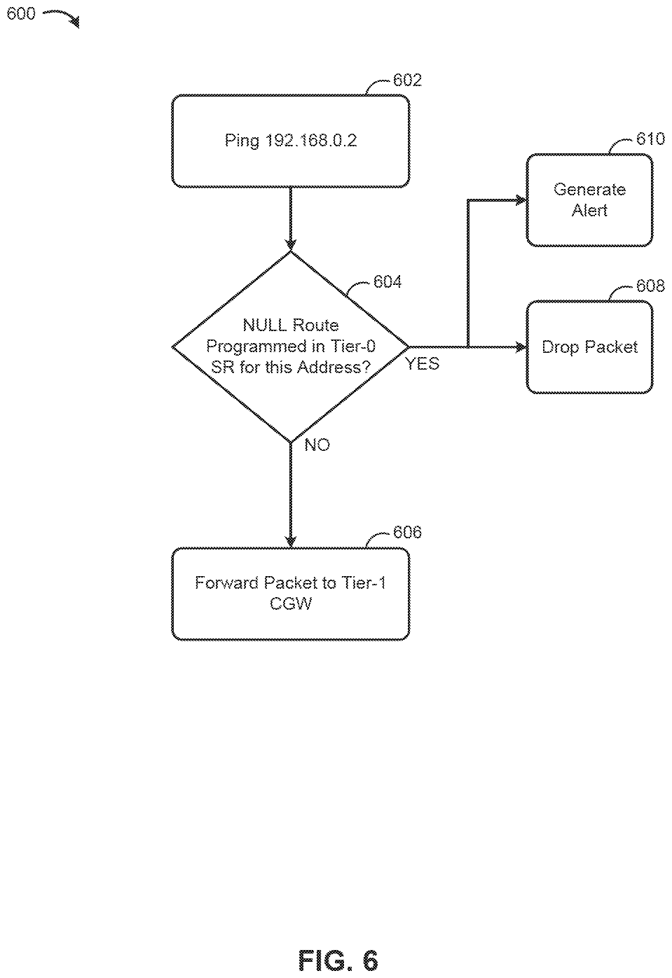

Furthermore, to remediate cases where a packet loop still may otherwise occur, cloud connection service sends instructions at step 560 to Tier-0 SR 230 to program one or more black hole routes having a null next hop based on the configured aggregation supernet. For example, a black hole route may be programmed for all network addresses that are included in the configured aggregation supernet but are not actually included in any of the logical segments behind the CGW for which the aggregation supernet was configured. In one embodiment, a black hole route is configured for all addresses within the configured aggregation supernet that are not currently assigned to an endpoint behind the CGW. Thus, if a packet addressed to a network address that is included in the configured aggregation supernet but not actually corresponding to an endpoint behind the CGW (or at least not actually being included within a logical segment behind the CGW) is received by Tier-0 SR 230, the packet will be dropped. Furthermore, as described in more detail below with respect to FIG. 6, a notification may be generated if such a packet is dropped, alerting the administrator to the situation. As such, embodiments of the present disclosure not only prevent misconfiguration, but also remediate cases where packet loops would otherwise occur and alert the administrator to the existence of such issues.

Black hole routes may be deleted if the corresponding aggregation supernet is removed. In some embodiments, an administrative distance of 250 is used for a black hole route so that if a customer wants to use the same aggregation supernet in another case, for example in the case of a Tier-1 SR using network address translation (NAT), then the additional use of that aggregation supernet will be programmed in a route with a lower administrative distance.

In some embodiments, the scheduler updates black hole routes as needed over time, such as if logical segments and/or endpoints are changed, added, or removed from behind a CGW. Furthermore, the administrator may be notified if a configured aggregation supernet that was previously verified for a CGW becomes inconsistent with a newly-computed supernet for the CGW. For example, if the scheduler computes an updated supernet for the CGW that is no longer consistent with the configured aggregation supernet for the CGW, the updated supernet may be recommended to the administrator as a configuration change.

Techniques described herein are more efficient that alternative techniques for avoiding packet loops, such as techniques involving the use of firewalls. For example, the use of black hole routes requires less computing resources than the use of firewall rules and may sustain a higher amount of throughput. Furthermore, black hole routes may be used even in cases where a firewall is not available or impractical to use. By avoiding packet loops at the edge gateway, embodiments of the present disclosure may improve the performance of the edge gateway and, consequently, the entire datacenter.

FIG. 6 is a flow chart 600 related to avoiding packet loops when routes are aggregated in a data center.

At step 602, a network address (192.168.0.2) is pinged. For example, a cloud service or an endpoint within the datacenter may direct a packet to the network address based on an advertised route (e.g., an advertised aggregation supernet for a Tier-1 CGW), and the packet may be received by the edge gateway (e.g., Tier-0 SR 230).

At step 604, the edge gateway determines whether a null route (or black hole route) is programmed for the network address. If a null route is not programmed for the network address, then the packet is forwarded at step 608 to the Tier-1 CGW. If a null route is programmed for the network address, then the packet is dropped at step 608 and an alert is generated at step 610. For example, a notification may be provided to an administrator, such as via a user interface associated with cloud connection service 410, alerting the administrator to the fact that a packet addressed to a network address within the configured aggregation supernet but not within any logical segment at the Tier-1 CGW was received by the edge gateway and dropped accordingly.

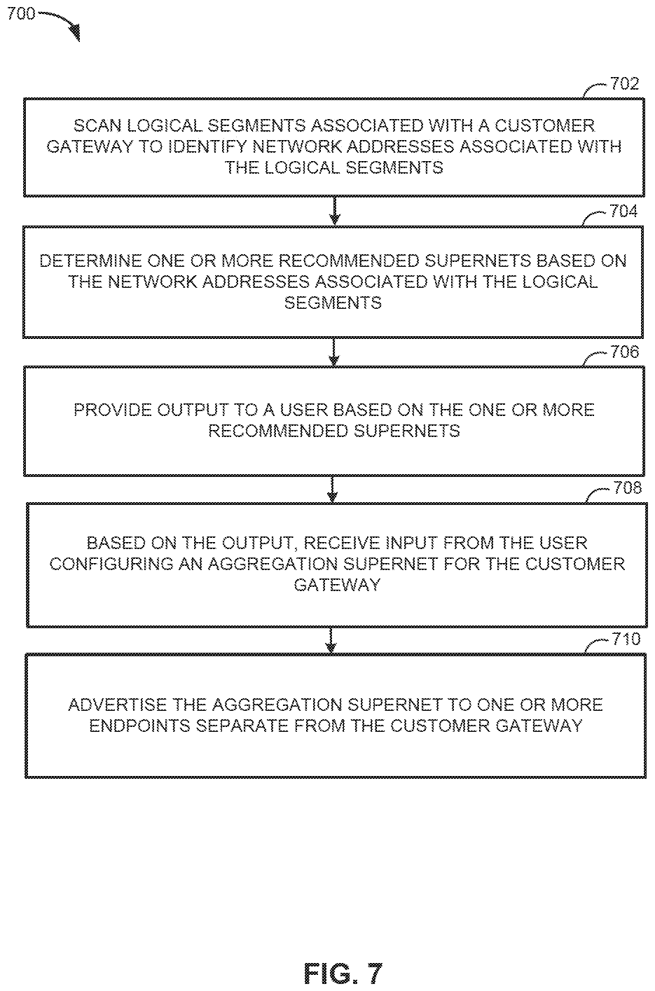

FIG. 7 depicts example operations 700 related to avoiding packet loops when routes are aggregated in a data center. For example, operations 700 may be performed by one or more components of data center 130 of FIG. 1.

Operations 700 begin at step 702, with scanning logical segments associated with a customer gateway to identify network addresses associated with the logical segments.

Operations 700 continue at step 704, with determining one or more recommended supernets based on the network addresses associated with the logical segments. In some embodiments, determining the one or more recommended supernets comprises converting the network addresses associated with the logical segments to a binary form and locating bits at which a common pattern of digits end.

Operations 700 continue at step 706, with providing output to a user based on the one or more recommended supernets. For example, the output may be based on comparing an initial aggregation supernet provided by the user to the one or more recommended supernets.

Operations 700 continue at step 708, with, based on the output, receiving input from the user configuring an aggregation supernet for the customer gateway.

Operations 700 continue at step 710, with advertising the aggregation supernet to one or more endpoints separate from the customer gateway.

Some embodiments further comprise configuring, at a service router, a null route in association with at least a subset of network addresses in the aggregation supernet, wherein the null route causes packets received at the service router that are directed to network addresses in the subset to be dropped. For example, the subset may comprise all network addresses in the aggregation supernet that are not in the network addresses associated with the logical segments.

Certain embodiments further comprise generating a notification when a packet is dropped based on the null route. The null route may comprise a null value for a next hop associated with a given network address in a routing table.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system—level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of avoiding packet loops when routes are aggregated in a data center, comprising:
scanning logical segments associated with a customer gateway to identify network addresses associated with the logical segments;
determining one or more recommended supernets based on the network addresses associated with the logical segments;
providing output to a user based on the one or more recommended supernets;
based on the output, receiving input from the user configuring an aggregation supernet for the customer gateway; and
advertising the aggregation supernet to one or more endpoints separate from the customer gateway.

2. The method of claim 1, further comprising configuring, at a service router, a null route in association with at least a subset of network addresses in the aggregation supernet, wherein the null route causes packets received at the service router that are directed to network addresses in the subset to be dropped.

3. The method of claim 2, wherein the subset comprises all network addresses in the aggregation supernet that are not in the network addresses associated with the logical segments.

4. The method of claim 2, further comprising generating a notification when a packet is dropped based on the null route.

5. The method of claim 2, wherein the null route comprises a null value for a next hop associated with a given network address in a routing table.

6. The method of claim 1, wherein the output is based on comparing an initial aggregation supernet provided by the user to the one or more recommended supernets.

7. The method of claim 6, wherein determining the one or more recommended supernets comprises converting the network addresses associated with the logical segments to a binary form and locating bits at which a common pattern of digits end.

8. A system for avoiding packet loops when routes are aggregated in a data center, the system comprising:
at least one memory; and
at least one processor coupled to the at least one memory, the at least one processor and the at least one memory configured to:
scan logical segments associated with a customer gateway to identify network addresses associated with the logical segments;
determine one or more recommended supernets based on the network addresses associated with the logical segments;
provide output to a user based on the one or more recommended supernets;
based on the output, receive input from the user configuring an aggregation supernet for the customer gateway; and
advertise the aggregation supernet to one or more endpoints separate from the customer gateway.

9. The system of claim 8, wherein the at least one processor and the at least one memory are further configured to configure, at a service router, a null route in association with at least a subset of network addresses in the aggregation supernet, wherein the null route causes packets received at the service router that are directed to network addresses in the subset to be dropped.

10. The system of claim 9, wherein the subset comprises all network addresses in the aggregation supernet that are not in the network addresses associated with the logical segments.

11. The system of claim 9, wherein the at least one processor and the at least one memory are further configured to generate a notification when a packet is dropped based on the null route.

12. The system of claim 9, wherein the null route comprises a null value for a next hop associated with a given network address in a routing table.

13. The system of claim 8, wherein the output is based on comparing an initial aggregation supernet provided by the user to the one or more recommended supernets.

14. The system of claim 13, wherein determining the one or more recommended supernets comprises converting the network addresses associated with the logical segments to a binary form and locating bits at which a common pattern of digits end.

15. A non-transitory computer-readable medium storing instructions that, when executed by one or more processors, cause the one or more processors to:
scan logical segments associated with a customer gateway to identify network addresses associated with the logical segments;
determine one or more recommended supernets based on the network addresses associated with the logical segments;
provide output to a user based on the one or more recommended supernets;
based on the output, receive input from the user configuring an aggregation supernet for the customer gateway; and
advertise the aggregation supernet to one or more endpoints separate from the customer gateway.

16. The non-transitory computer-readable medium of claim 15, wherein the instructions, when executed by the one or more processors, further cause the one or more processors to configure, at a service router, a null route in association with at least a subset of network addresses in the aggregation supernet, wherein the null route causes packets received at the service router that are directed to network addresses in the subset to be dropped.

17. The non-transitory computer-readable medium of claim 16, wherein the subset comprises all network addresses in the aggregation supernet that are not in the network addresses associated with the logical segments.

18. The non-transitory computer-readable medium of claim 16, wherein the instructions, when executed by one or more processors, further cause the one or more processors to generate a notification when a packet is dropped based on the null route.

19. The non-transitory computer-readable medium of claim 16, wherein the null route comprises a null value for a next hop associated with a given network address in a routing table.

20. The non-transitory computer-readable medium of claim 15, wherein the output is based on comparing an initial aggregation supernet provided by the user to the one or more recommended supernets.
